(19) United States
(12) Patent Application Publication
(10) Pub. No.: US 2018/0216576 A1
(43) Pub. Date: Aug. 2, 2018

(54) SUPERSONIC TURBOFAN ENGINE

(71) Applicant: General Electric Company, Schenectady, NY (US)

(72) Inventors: Brandon Wayne Miller, Liberty Township, OH (US); Mark John Laricchiuta, West Chester, OH (US); Daniel Robert Dwyer, West Chester, OH (US); Jeffrey Donald Clements, Mason, OH (US); Kenneth Scheffel, Edgewood, KY (US); Thomas Ory Moniz, Loveland, OH (US)

(21) Appl. No.: 15/293,358

(22) Filed: Oct. 14, 2016

(51) Int. Cl. F02K 3/075; B64D 29/00

(52) U.S. Cl. CPC F02K 3/075; F05D 2260/96; F05D 2220/80; B64D 29/00

(57) ABSTRACT

A supersonic turbofan engine includes a fan section having a single-stage fan defining a fan pressure ratio greater than 1.9. The supersonic turbofan engine also includes a core turbine engine defining a core air flowpath. A nacelle at least partially surrounds the fan of the fan section and the core turbine engine. The supersonic turbofan engine defines a bypass ratio, the bypass ratio being greater than or equal to three.

### FIELD OF THE INVENTION

The present subject matter relates generally to a gas turbine engine, or more particularly to a gas turbine engine bearing assembly configuration.

### BACKGROUND OF THE INVENTION

A gas turbine engine generally includes a fan and a core arranged in flow communication with one another. The core of the gas turbine engine generally includes, in serial flow order, a compressor section, a combustion section, a turbine section, and an exhaust section. In at least certain gas turbine engines further include a nacelle extending around and surrounding at least a portion of the fan and the core. The nacelle may be supported by, and mechanically coupled to, the core and/or fan by a plurality of struts. For gas turbine engines including a single stage fan, the struts are positioned in relatively close proximity to the fan blades, such that they may act as outlet guide vanes for the fan.

For gas turbine engines operating at supersonic flight speeds, i.e., flights be greater than Mach 1, the fan typically includes a plurality of stages to define a relatively high overall fan pressure ratio. However, these gas turbine engines may generate a relatively large amount of acoustic disturbance (i.e., noise) when operating at supersonic flight speeds. While this is generally acceptable for military applications, this acoustic disturbance may limit the gas turbine engine's use for commercial applications given noise limit restrictions for commercial aircraft over land.

Accordingly, a gas turbine engine capable of operating at supersonic flight speeds while generating less acoustic disturbance during operation would be useful.

### BRIEF DESCRIPTION OF THE INVENTION

Aspects and advantages of the invention will be set forth in part in the following description, or may be obvious from the description, or may be learned through practice of the invention.

In one exemplary embodiment of the present disclosure, a supersonic turbofan engine is provided. The supersonic turbofan engine includes a fan section having a single-stage fan defining a fan pressure ratio greater than 1.9. The supersonic turbofan engine also includes a core turbine engine defining a core air flowpath and an inlet to the core air flowpath. The supersonic turbofan engine also includes a nacelle at least partially surrounding the fan of the fan section and the core turbine engine. The nacelle defines a bypass passage with the core turbine engine. The supersonic turbofan engine defines a bypass ratio greater than or equal to three (3). The bypass ratio is a ratio of an airflow through the bypass passage to an airflow through the inlet of the core turbine engine during operation of the supersonic turbofan engine.

In one exemplary aspect of the present disclosure, a method of operating a supersonic turbofan engine is provided. The supersonic turbofan engine includes a single-stage fan and defines a bypass ratio. The method includes operating the supersonic turbofan engine at subsonic flight speeds, and operating the supersonic turbofan engine at supersonic flight speeds, with the supersonic turbofan engine defining a bypass ratio greater than or equal to three (3) and the single-stage fan defining a fan pressure ratio greater than 1.9.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross-sectional view of an exemplary gas turbine engine according to various embodiments of the present subject matter.

FIG. 2 is a flow diagram of a method for operating a supersonic turbofan engine.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

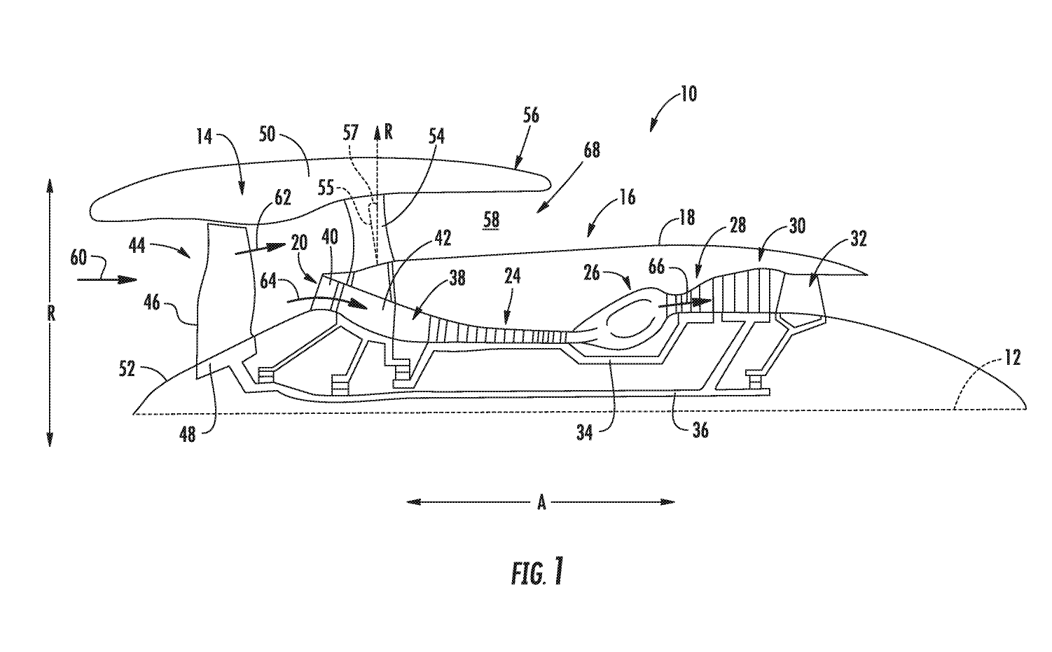

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine engine is a supersonic turbofan jet engine 10, referred to herein as “turbofan engine 10.” Although described with reference to an exemplary embodiment of the supersonic turbofan engine 10, in other exemplary aspects of the present disclosure, the turbofan engine 10 may have any other suitable configuration. For example, as will be appreciated, in other exemplary embodiments of the present disclosure, the turbofan engine 10 may include any other suitable number of compressors, turbines, and/or spools.

As shown in FIG. 1, the turbofan engine 10 defines an axial direction A (extending parallel to a longitudinal centerline 12 provided for reference), a radial direction R, and a circumferential direction (i.e., a direction extending about the axial direction A; not depicted). In general, the turbofan 10 includes a fan section 14 and a core turbine engine 16 disposed downstream from the fan section 14.

The exemplary core turbine engine 16 depicted generally includes a substantially tubular outer casing 18 that defines an annular inlet 20. The outer casing 18 encases, in serial flow relationship, a compressor section including a single compressor, which may be referred to as a high pressure (HP) compressor 24; a combustion section 26; a turbine section including a high pressure (HP) turbine 28 and a low pressure (LP) turbine 30; and a jet exhaust nozzle section 32. A high pressure (HP) shaft or spool 34 drivingly connects the HP turbine 28 to the HP compressor 24. A low pressure (LP) shaft or spool 36 drivingly connects the LP turbine 30 to the fan section 14.

The compressor section, combustion section 26, turbine section, and jet exhaust nozzle section 32 together define a core air flowpath 38 through the core turbine engine 16. Notably, for the embodiment depicted, the core turbine engine 16 further includes a stage of inlet guide vanes 40 at a forward end of the core air flowpath 38, as well as a plurality of struts 42 extending through the core air flowpath 38 at a location forward of the HP compressor 24. The plurality of struts 42 may provide structural support for the core turbine engine 16.

For the embodiment depicted, the fan section 14 includes a fixed-pitch fan 44 having a plurality of fan blades 46 coupled to a disk 48 in a spaced apart manner. More specifically, for the embodiment depicted, the fan 44 is a single stage fan, i.e., a fan having a single stage of fan blades 46. As depicted, the fan blades 46 extend outwardly from the disk 48 generally along the radial direction R. The fan blades 46 and disk 48 are together rotatable about the longitudinal axis 12 by LP shaft 36. Additionally, the exemplary turbofan engine 10 depicted is configured as a direct drive turbofan engine. More specifically, the exemplary turbofan 10 depicted does not include a reduction gearbox, or power gearbox, between the LP shaft 36 and the fan section 14, and instead, the LP shaft 36 is directly mechanically connected to the fan 44 of the fan section 14.

During operation of the turbofan engine 10, the fan 44 of the turbofan engine 10 defines a fan pressure ratio. The fan pressure ratio refers to a ratio of a pressure immediately upstream of the plurality of fan blades 46 to a pressure immediately downstream of the plurality of fan blades 46 during operation of the fan 44 at a rated speed. For the embodiment depicted, the fan 44 of the turbofan engine 10 defines a fan pressure ratio greater than 1.9. For example, in certain exemplary embodiments, the fan pressure ratio may be greater than or equal to 2.0.

Referring still to the exemplary embodiment of FIG. 1, the disk 48 is covered by rotatable front hub 52 aerodynamically contoured to promote an airflow through the plurality of fan blades 46. Additionally, the exemplary fan section 14 includes an annular fan casing or outer nacelle 50 that circumferentially surrounds the fan 44 and/or at least a portion of the core turbine engine 16. Moreover, a downstream section 56 of the nacelle 50 extends over an outer portion of the core turbine engine 16 so as to define a bypass airflow passage 58 therebetween.

The exemplary nacelle 50 depicted is mechanically coupled to the core turbine engine 16 by a stage of circumferentially-spaced outlet guide vanes 54. For the embodiment depicted, each outlet guide vane 54 in the stage of outlet guide vanes 54 extends between the core turbine engine 16 and the nacelle 50, and more specifically, extends between the core turbine engine 16 and the nacelle 50 at a location downstream, or aft, of the inlet 20 to the core air flowpath 38. Moreover, each of the outlet guide vanes 54 for the embodiment depicted extend substantially along the radial direction R. Particularly, for the embodiment depicted, each of the outlet guide vanes 54 defines a centerline 55 (i.e., a line extending along a center of the outlet guide vane 54 relative to the axial direction A). The centerlines 55 of each of the outlet guide vanes 54 defines an angle 57 with the radial direction R less than about thirty degrees (30°), such as less than about twenty degrees (20°), such as less than about ten degrees (10°). Additionally, for the embodiment depicted, the outlet guide vanes 54 are forward-swept, such that they are tilted slightly forward (i.e., each outlet guide vane 54 extends towards the fan 44 as it extends outwardly generally along the radial direction R from the casing 18). Moreover, for the embodiment depicted, each of the centerlines 55 are substantially straight. However, in other embodiments, wherein for example, the centerline 55 may be curved, the angle 102 may be defined with a line of best fit to the centerline 55, as determined using a least mean square estimate.

During operation of the turbofan engine 10, a volume of air 60 enters the turbofan 10 through the nacelle 50 and/or fan section 14 (the air 60 unobstructed from an inlet of the nacelle 50 to the plurality of fan blades 46). As the volume of air 60 passes across the fan blades 46, a first portion of the air 60, as indicated by arrows 62, is directed or routed into the bypass airflow passage 58 and a second portion of the air 60, as indicated by arrow 64, is directed or routed into the core air flowpath 38, and more specifically, into the inlet 20 defined by the core turbine engine 16 to the core air flowpath 38. The ratio between the first portion of air 62 through the bypass airflow passage 58 and the second portion of air 64 through the inlet 20 of the core turbine engine 16 is commonly known as a bypass ratio. For the present disclosure, the turbofan engine 10 defines a bypass ratio greater than or equal to three (3) and less than ten (10). For example, in certain exemplary embodiments, the bypass ratio may be greater than or equal to four (4) and less than or equal to seven (7), such as greater than or equal to four and a half (4.5) and less than or equal to six (6).

Referring still to FIG. 1, the pressure of the second portion of air 64 is increased as it is routed through the HP compressor 24 and into the combustion section 26, where it is mixed with fuel and burned to provide combustion gases 66. The combustion gases 66 are routed through the HP turbine 28 where a portion of thermal and/or kinetic energy from the combustion gases 66 is extracted via sequential stages of HP turbine stator vanes that are coupled to the outer casing 18 and HP turbine rotor blades that are coupled to the HP shaft or spool 34 (not labeled), thus causing the HP shaft or spool 34 to rotate, thereby supporting operation of the HP compressor 24. The combustion gases 66 are then routed through the LP turbine 30 where a second portion of thermal and kinetic energy is extracted from the combustion gases 66 via sequential stages of LP turbine stator vanes that are coupled to the outer casing 18 and LP turbine rotor blades that are coupled to the LP shaft 36 or spool 36 (not labeled), thus causing the LP shaft 36 or spool 36 to rotate, thereby supporting operation of the fan 44.

The combustion gases 66 are subsequently routed through the jet exhaust nozzle section 32 of the core turbine engine 16 to provide propulsive thrust. Simultaneously, a pressure of the first portion of air 62 is substantially increased as the first portion of air 62 is routed through the bypass airflow passage 56 before it is exhausted from a fan nozzle exhaust section 68 of the turbofan 10, also providing propulsive thrust.

Further, for the embodiment depicted, the turbofan engine 10 is configured as a supersonic turbofan engine 10 configured to operate at flight speeds greater than Mach 1. Such may be accomplished due to the various design parameters of the turbofan engine 10, such as the single-stage fan 44 and booster-less compressor section (i.e., the compressor section including a single, HP compressor 24). Additionally, other design parameters, such as a fan pressure ratio, a bypass ratio, a fan diameter, an overall pressure ratio, etc., have been considered.

Referring still to FIG. 1, it will be appreciated that the airflow 64 from the single stage fan 44 is unobstructed along the axial direction A between the single stage fan 44 and the inlet 20 to the core air flowpath 38. In addition, the airflow 62 from the single stage fan 44 is also unobstructed along the axial direction A between a single stage fan 44 and the stage of outlet guide vanes 54. As will be appreciated, such may allow for operation of the turbofan engine 10 at supersonic speeds while reducing an acoustic disturbance generated during such operations.

A turbofan engine configured in accordance with one or more the exemplary embodiments of the present disclosure may allow for operation of the turbofan engine at supersonic flight speeds while reducing an acoustic disturbance generated by the turbofan engine. Additionally, utilizing a single stage fan defining a fan pressure ratio in accordance with an exemplary aspect of the present disclosure may provide for a lighter turbofan engine, and a more axially compact turbofan engine. Additionally, the inventors of the present disclosure have discovered that coupling the single-stage fan, defining a fan pressure ratio in accordance with the present disclosure, with a bypass ratio within the ranges described herein provide for a desired efficiency when operated at supersonic flight speeds.

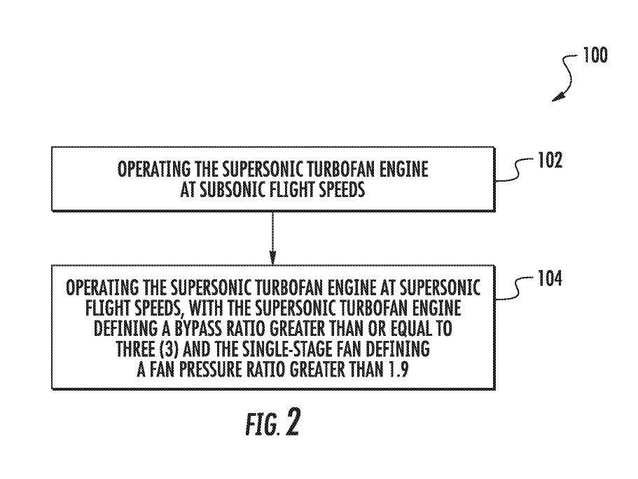

Referring now to FIG. 2, a method (100) of operating a supersonic turbofan engine in accordance with an exemplary aspect of the present disclosure is provided. The method (100) may be utilized in certain exemplary aspects with the exemplary turbofan engine 10 described above with reference to FIG. 1. Accordingly, the method (100) may be utilized with a supersonic turbofan engine including a single stage fan defining a fan pressure ratio. Additionally, the supersonic turbofan engine may define a bypass ratio.

As is depicted in FIG. 2, the exemplary method (100) includes at (102) operating the supersonic turbofan engine at subsonic flight speeds, i.e., speeds less than Mach 1. Operating the supersonic turbofan engine at subsonic flight speeds at (102) may include operating the gas turbine engine during takeoff operating modes, landing operating modes, and/or taxiing operating modes. In addition, the exemplary method (100) includes at (104) operating the supersonic turbofan engine at supersonic flight speeds, i.e., speeds greater than Mach 1, with the supersonic turbofan engine defining a bypass ratio greater than or equal to three (3) and the single-stage fan defining a fan pressure ratio greater than 1.9. Operating the supersonic turbofan engine at supersonic flight speeds at (104) may take place subsequent to operating the supersonic turbofan engine at subsonic flight speeds at (102), or alternatively, prior to operating the supersonic turbofan engine at subsonic flight speeds at (102). Further, operating a supersonic turbofan engine in accordance with one or more exemplary aspects of the present disclosure may allow for operating the supersonic turbofan engine at supersonic flight speeds, while meeting certain efficiency limitations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A supersonic turbofan engine comprising:
a fan section comprising a single-stage fan defining a fan pressure ratio greater than 1.9;
a core turbine engine defining a core air flowpath and an inlet to the core air flowpath; and
a nacelle at least partially surrounding the fan of the fan section and the core turbine engine, the nacelle defining a bypass passage with the core turbine engine, the supersonic turbofan engine defining a bypass ratio greater than or equal to three (3), the bypass ratio being a ratio of an airflow through the bypass passage to an airflow through the inlet of the core turbine engine during operation of the supersonic turbofan engine.

2. The supersonic turbofan engine of claim 1, wherein the fan pressure ratio is greater than 2.0.

3. The supersonic turbofan engine of claim 1, wherein the bypass ratio is less than ten (10).

4. The supersonic turbofan engine of claim 1, wherein the bypass ratio is greater than or equal to four (4) and less than or equal to seven (7).

5. The supersonic turbofan engine of claim 1, wherein an airflow from the single-stage fan is unobstructed along the axial direction between the single-stage fan and the inlet to the core air flowpath.

6. The supersonic turbofan engine of claim 5, wherein the turbofan engine further comprises a stage of outlet guide vanes extending between the core turbine engine and the nacelle, and wherein the airflow from the single-stage fan is also unobstructed along the axial direction between the single-stage fan and the stage of outlet guide vanes.

7. The supersonic turbofan engine of claim 1, wherein the gas turbine engine is a direct drive gas turbine engine.

8. The supersonic turbofan engine of claim 1, wherein the supersonic gas turbine engine configured to be mounted to an aircraft designed to operate at flight speeds greater than Mach 1.

9. The supersonic turbofan engine of claim 1, wherein the core turbine engine comprises a compressor section, and wherein the compressor section comprises a single compressor.

10. The supersonic turbofan engine of claim 1, wherein the core turbine further comprises a stage of outlet guide vanes, and wherein the stage of outlet guide vanes extend between the core turbine engine and the nacelle at a location downstream from the inlet to the core air flowpath.

11. The supersonic turbofan engine of claim 10, wherein each of the outlet guide vanes extend substantially along the radial direction.

12. The supersonic turbofan engine of claim 10, wherein each of the outlet guide vanes define a centerline, and wherein each centerline defines an angle with the radial direction less than about thirty degrees (30°).

13. A method of operating a supersonic turbofan engine comprising a single-stage fan and defining a bypass ratio, the method comprising:
operating the supersonic turbofan engine at subsonic flight speeds; and
operating the supersonic turbofan engine at supersonic flight speeds, with the supersonic turbofan engine defining a bypass ratio greater than or equal to three (3) and the single-stage fan defining a fan pressure ratio greater than 1.9.

14. The method of claim 13, wherein operating the supersonic turbofan engine at supersonic flight speeds includes operating the supersonic turbofan engine at supersonic flight speeds with the single-stage fan defining pressure ratio greater than 2.0.

15. The method of claim 13, wherein operating the supersonic turbofan engine at supersonic flight speeds includes operating the supersonic turbofan engine at supersonic flight speeds with the bypass ratio being less than or equal to ten (10).

16. The method of claim 13, wherein operating the supersonic turbofan engine at supersonic flight speeds includes operating the supersonic turbofan engine at supersonic flight speeds with the bypass ratio being greater than or equal to four (4) and less than or equal to seven (7).

17. The method of claim 13, wherein an airflow from the single-stage fan is unobstructed along the axial direction between the single-stage fan and the inlet to the core air flowpath.

18. The method of claim 17, wherein the core turbine further comprises a stage of outlet guide vanes, and wherein the airflow from the single-stage fan is also unobstructed along the axial direction between the single-stage fan and the stage of outlet guide vanes.

19. The method of claim 13, wherein the core turbine engine comprises a compressor section, and wherein the compressor section comprises a single compressor.

20. The method of claim 13, wherein the core turbine further comprises a stage of outlet guide vanes, and wherein the stage of outlet guide vanes extend between the core turbine engine and the nacelle at a location downstream from the inlet to the core air flowpath.
